(19) United States
(12) Patent Application Publication
(10) Pub. No.: US 2023/0039324 A1
(43) Pub. Date: Feb. 9, 2023

(54) A CONFIRMATION METHOD AND SYSTEM WITH PROGRAMMABLE DEVICES

(71) Applicant: TORCH YAZILIM LIMITED SIRKETI, Istanbul (TR)

(72) Inventor: Mustafa VARDALI, Istanbul (TR)

(21) Appl. No.: 17/758,793

(22) PCT Filed: Mar. 11, 2020
(86) PCT No.: PCT/TR2020/050197

§ 371 Date: Jul. 13, 2022

(30) Foreign Application Priority Data
Jan. 17, 2020 (TR) 2020/00707

(51) Int. Cl. H04L 9/08; H04L 67/02; G06F 9/54

(52) U.S. Cl. CPC H04L 9/0841; H04L 67/02; G06F 9/54

(57) ABSTRACT

Disclosed are a confirmation system and method which enables confirmation of the users of the application/device owners without using SMS in an easy manner.

### TECHNICAL FIELD

The invention relates to a confirmation system and method which provides confirmation in an easy manner in relation with the users of the application/device owners supported in the software industry.

### STATE OF THE ART

Today, there is requirement for confirming the users in the applications/devices according to the rendered services. Cellular phone information is used in general in order to confirm the user. Therefore, a password is generated which is valid for once and is sent to the cellular phone of the user via a SMS, thus the confirmation of the cellular phone number is performed. Confirmation of the cellular phone number via SMS presents various difficulties, both in terms of cost and in terms of user experience. The owner of the application/device cannot be able to have SMS service in any country properly, the costs are so high.

In the present state of the art, in document no TR 2017/20645, a system for CRM applications which serves through face to face channels is described, wherein, the customer confirmation method is centralized, any screen in the application is restricted from performing any process without performing one of the confirmation options and confirmation method is made definitional and different confirmation options can be applied particularly according to the required process.

In the present state of the art, in another document No US2019340610A1, a computerized system is disclosed. Said system performs customer identification processes for the customers who log in their accounts remotely by their personal identity numbers which cannot be confirmed by the existing data sources.

However, there is no structure which has the same aspects and process steps as the technique of our invention in the current systems. The abovementioned problems makes in necessary to develop a novel user confirmation system.

### AIMS OF THE INVENTION

The main aim of the invention is to provide a confirmation system and method to the application and/or devices requiring confirmation.

Another main aim of the invention is to provide a confirmation system and method which is very cost effective.

Another main aim of the invention is to provide a confirmation system and method which facilitates the user experience of the final user, eliminates SMS requirement by using other systems that are already maintained.

Another aim of the invention is to allow API developers to use the confirmation flows easily by means of integrating into the system easily.

The invention is a confirmation system in order to achieve the abovementioned aims, which enables confirmation of the device or applications of the final users by means of integrating thereof to the final user devices or applications over a web site where the users are registered, comprising the following,
at least one confirmation system server which is in communication with at least one customized application server that allows the applications to run on the final user device, provides communication with the integrated application or SDK in the device,
at least one database which stores data for encoding and confirmation processes,
at least one caching server where the localization information and static information are stored,
at least one software server on which the software runs, which transfers, processes the information in the system between the elements, creates and controls unique confirmation codes for opening the applications and session ID information containing the user information,
at least one reporting module which has a panel and a reporting server, transmits the reports in relation with the confirmation statistics of the applications to the user visually,
at least one client server which sends and receives the encoding keys created specific to each registered application by the software.

Also, the invention is a confirmation method in order to achieve the abovementioned aims, which enables confirmation of the device or applications of the final users by means of integrating thereof to the final user devices or applications over a web site where the users are registered, comprising the following process steps,
after the owners of the application or end user device are registered to the confirmation system over the web site, encoding key is created and downloaded by the software, adding SDK (Software development kit) information to API (Application Programming Interface),
initiating the communication according to the diffie-hellman key change algorithm via the software server by means of API that initiates confirmation with SDK,
creating and storing a unique encoding key for the confirmation request in a database by means of the software,
controlling the applications on the final user device by means of said SDK,
opening the application selected by the user, sending the unique confirmation code created by the software to the user,
accessing API, listening to the received messages and controlling the confirmation code by means of the software server,
creating a unique session ID (identity) in the data base to receive the user information by the software together with the confirmation code is verified,
transmitting the session ID information received from the software server to the application by means of SDK,
requesting an encoding key from the customized application server of the application to the software servers,
confirming the encoding key and session ID information and transmitting the user information by means of the software servers.

### BRIEF DESCRIPTION OF FIGURES

The structural and characteristic features of the present invention will be understood clearly by the following drawings and the detailed description made with reference to these drawings and therefore the evaluation shall be made by taking these FIGURES and the detailed description into consideration.

FIG. 1 is an illustrative view of the inventive confirmation system.

### REFERENCE NUMBERS

1. Confirmation System Server
10. Database
11. Caching Server
12. Software Server
13. Confirmation Code
14. API
15. Session ID
16. User Information
17. Panel and Reporting Server
18. Reporting Module
2. SDK
3. Final User Device
4. Customer Server
41. Encoding Key
5. Customized Application Server

### DETAILED DESCRIPTION OF THE INVENTION

In this detailed description, the inventive confirmation system and method are described only for clarifying the subject in an illustrative manner and in a manner without creating any limiting effect.

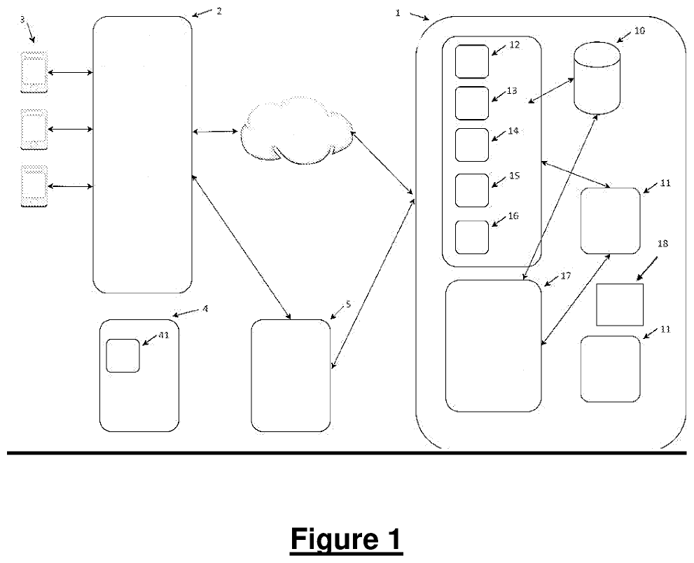

An illustrative view of the confirmation system which enables confirmation of the device (3) or applications of the final users by means of integrating thereof to the final user devices (3) or applications over a web site where the users are registered is given in FIG. 1. In said system, there are the following; at least one confirmation system server (1) which is in communication with at least one customized application server (5) that allows the applications to run on the final user device (3), provides communication with the integrated application or SDK (2) in the device (3), at least one database (10) which stores data for encoding and confirmation processes, at least one caching server (11) where the localization information and static information are stored, at least one software server (12) on which the software runs, which transfers, processes the information in the system between the elements, creates and controls unique confirmation codes (13) for opening the applications and session ID (15) information containing the user information (16), at least one reporting module (18) which has a panel and a reporting server (17), transmits the reports in relation with the confirmation statistics of the applications (4) to the user visually, at least one client server (4) which sends and receives the encoding keys (41) created specific to each registered application by the software.

In the system, after the owners of the application or final user device (3) register to the confirmation system over the web site by means of e-mail address and a password determined by them, the application desired to be used is saved by means of the software. When the encoding key (41) is created and downloaded by means of the software, SDI (Software development kit) (2) information is added to API (14) and the confirmation process is initiated. The final user can be able to access, update or invalidate the encoding key of the application by means of logging in via web site at any desired time. Subsequently, after the application initiates confirmation with SDK (2), the software server (12) initiates communication according to the diffie-hellman key change algorithm.

After the customer registration, the software creates and stores a unique encoding key (41) in a data base (10) for confirmation request. At this time, the application or device information required to be used are stored in the code library. All communication between the code library of the software and the software server (12) is stored by this specific encoding key (41) of any application stored in the data base (10). The code library of the software encodes all requests and the software server (12) will only respond when the encoding in the received request is decoded by means of the encoding key (41) of the application in a successful manner.

Said SDK (2) controls the applications on the final user device (3) and the application selected by the user is opened, and the unique confirmation code (13) created by the software is sent to the user. The software can be able to determine all other applications to be used for confirmation in the final user device (3) by means of the software server (12). After this determination, the authorized applications stored in the data base (10) are compared. And unique confirmation code (13) is formed. Only authorized applications are responded by means of said confirmation code (13). Subsequently, the software server (12) controls the confirmation code (13) after accessing to API (14) and listening to the received messages. Herein, the software sends the confirmation code (13) to the assigned number during registration and compares the registered information in the database (10) after listening to the received messages and received confirmation code (13).

After the confirmation code (13) is verified, a unique session ID (15) (identity) is created in the database (10) and SDK (3) transmits session ID (15) information received from the software server (12) to the application in order to receive the user information (16) by means of the software. Here after the software approves the confirmation code (13) by means of the software server (12), sends the final user successful information and sends the application user information (16) and unique session ID (15) information with a validity period. Subsequently, after the application requests encoding key (41) from the customized application server (5) of the application to the software servers (2), if the software servers (2) confirms the encoding key (41) and session ID (15) information, the user information (16) is transmitted.

Thus, the final user can be able to complete the confirmation steps in a safe manner. The software keeps this session ID (15) information which is beneficial for receiving the user information (16) in the data base (10) of the software server (12) for a determined period of time. The application can also keep this session ID (15) information in a safe place on the final user device (3) for a determined period of time. After the confirmation of the user, if the application is terminated without receiving the information with the session ID (15) by the application, when the user enters the application again, the application (15) can be able to receive the user information (16) with the session ID (15) in hand without involving the user in the confirmation steps again.

A confirmation method which enables confirmation of the device (3) or applications of the final users by means of integrating thereof to the final user devices (3) or applications over a web site where the users are registered, comprising the following process steps;
after the owners of the application or end user device (3) are registered to the confirmation system over the web site, encoding key (41) is created and downloaded by the software, adding SDK (Software development kit) (2) information to API (Application Programming Interface) (14),
initiating the communication according to the diffie-hellman key change algorithm via the software server (12) by means of API (14) that initiates confirmation with SDK (2),
creating and storing a unique encoding key (41) for the confirmation request in a database (10) by means of the software,
controlling the applications on the final user device (3) by means of said SDK (2),
opening the application selected by the user, sending the unique confirmation code (13) created by the software to the user,
accessing API (14), listening to the received messages and controlling the confirmation code (13) by means of the software server (12),
creating a unique session ID (identity) (15) in the data base (10) to receive the user information (16) by the software together with the confirmation code (13) is verified,
transmitting the session ID (15) information received from the software server (12) to the application by means of SDK (3),
requesting an encoding key (41) from the customized application server (5) of the application to the software servers (2),
confirming the encoding key (41) and session ID (15) information and transmitting the user information (16) by means of the software servers (2).

### Abbreviations

### SDK: Software Development Kit

### ID: Identity

### API: Application Programming Interface

1. A confirmation system which enables confirmation of a device or applications of final users by means of integrating thereof to final user devices or applications over a web site where the users are registered, the system comprising: characterized in that; it comprises the following,
at least one confirmation system server which is in communication with at least one customized application server that allows the applications to run on the final user device, provides communication with an integrated application or SDK in the device;
at least one database which stores data for encoding and confirmation processes;
at least one caching server where localization information and static information are stored;
at least one software server on which the software runs, which transfers, processes the information in the system between the elements, creates and controls unique confirmation codes for opening the applications and session ID information containing user information;
at least one reporting module which has a panel and a reporting server, transmits the reports in relation with the confirmation statistics of the applications to the user visually; and
at least one client server which sends and receives encoding keys created specific to each registered application by the software.

2. A confirmation method which enables confirmation of a device or applications of final users by means of integrating thereof to final user devices or applications over a web site where the users are registered, comprising:
after owners of the application or end user device are registered to the confirmation system over the web site, an encoding key is created and downloaded by the software, adding SDK (Software development kit) information to API (Application Programming Interface);
initiating the communication according to the diffie-hellman key change algorithm via the software server by means of API that initiates confirmation with SDK;
creating and storing a unique encoding key for the confirmation request in a database by means of the software;
controlling the applications on the final user device by means of said SDK;
opening the application selected by the user, sending the unique confirmation code created by the software to the user;
accessing API, listening to the received messages and controlling the confirmation code by means of the software server;
creating a unique session ID (identity) in the data base to receive the user information by the software together with the confirmation code is verified;
transmitting the session ID information received from the software server to the application by means of SDK;
requesting an encoding key from the customized application server of the application to the software servers; and
confirming the encoding key and session ID information and transmitting the user information by means of the software servers.
